(19) United States
(12) Patent Application Publication
(10) Pub. No.: US 2013/0066982 A1
(43) Pub. Date: Mar. 14, 2013

(54) INFORMATION TRANSMISSION SUPPORT DEVICE, INFORMATION TRANSMISSION SUPPORT METHOD AND RECORDING MEDIUM

(71) Applicants: Naoki Yoshinaga, Tokyo (JP); Satoko Itaya, Tokyo (JP); Peter Davis, Kyoto (JP); Rle Tanaka, Tokyo (JP); Taku Konishi, Tokyo (JP); Shinichi Doi, Tokyo (JP)

(72) Inventors: Naoki Yoshinaga, Tokyo (JP); Satoko Itaya, Tokyo (JP); Peter Davis, Kyoto (JP); Rle Tanaka, Tokyo (JP); Taku Konishi, Tokyo (JP); Shinichi Doi, Tokyo (JP)

(73) Assignee: NEC Corporation

(21) Appl. No.: 13/520,421

(22) PCT Filed: Dec. 28, 2010
(86) PCT No.: PCT/JP10/73798

§ 371 Date: Aug. 20, 2012

(30) Foreign Application Priority Data
Jan. 5, 2010 (JP) 2010-000311

(51) Int. Cl. G06F 15/16

(52) U.S. Cl. 709/206

(57) ABSTRACT

An information obtaining unit (11) obtains transmission-intended information input by an information sender, a candidate propagation NW obtaining unit (12) searches and obtains a candidate propagation network corresponding to the kind of the transmission-intended information among propagation networks each including information on a sender user, a recipient user, a kind of information transmitted from the sender user to the recipient user, and a number, a probability, a time or a combination thereof of transmission of the information of the kind from the sender user to the recipient user. A recommended propagation NW specifying unit (13) obtains, among the candidate propagation networks, the candidate propagation network having the highest expected value of the total number of the users to whom information will be propagated within a predetermined time as a recommended propagation network. A display generator unit (14) presents the recommended propagation network to the information sender.

### TECHNICAL FIELD

The present invention relates to an information transmission support device, an information transmission support method, and a recording medium.

### BACKGROUND ART

Broadcasting information service systems, such as direct mails, television commercials, and electronic mail advertisements, which transmit the same information to a large number of users are widely used as effective schemes for marketing and advertising. However, since broadcasting information services are quite often carried out, users often doubt the credibility and do not feel the importance of broadcasted information transmitted from the systems in a unilateral way. To address this problem, a solution is available which corresponds to individual users to cause the users to feel the importance of transmitted information by, for example, changing the information to be transmitted from the information service systems user by user, but when the number of users subjected to the information service is large, it is costly and is not practical.

In order to address such a problem, an information transmission scheme is getting attention which does not directly transmit information to all users subjected to the information service but transmits the information to a small number of users among all users, and which expects that the information will spread widely from such users by word-of-mouth and person-to-person. According to this scheme, the number of users to whom the information is directly transmitted is small, it does not take costs and can correspond to individual users.

Patent Literature 1 discloses an information service system that allows a person who provides information to track and analyze the information transmission like word-of-mouth communication among consumers. Moreover, Patent Literature 1 also discloses a research result that information transmitted by close relatives through word-of-mouth communication is relatively more trusted than other information like advertisement.

Patent Literature 2 discloses an information service device which provides information based on, for example, the power of influence of an individual user in a social network, and the power of influence of the user in a social network and which can expect the high possibility of word-of-mouth information propagation.

Patent Literature 3 discloses a spontaneous information propagation managing system which allows propagation to other users without an explicit transfer action and which can find an appropriate propagation destination.

Patent Literature 4 discloses a technology of obtaining a profile effective for marketing based on the collected log information, and estimating an opinion leader. The technology disclosed in Patent Literature 4 simulates the information propagation based on the profile and an information category presented to the selected opinion leader.

### PRIOR ART DOCUMENTS

### Patent Literatures

Patent Literature 1: Unexamined Japanese Patent Application KOKAI Publication No. 2004-70541
Patent Literature 2: Unexamined Japanese Patent Application KOKAI Publication No. 2008-257512
Patent Literature 3: Unexamined Japanese Patent Application KOKAI Publication No. 2005-56176
Patent Literature 4: Unexamined Japanese Patent Application KOKAI Publication No. 2004-362208

### DISCLOSURE OF INVENTION

### Problems to be Solved by the Invention

The information transmission scheme of word-of-mouth communication can cause the users to have more credibility in comparison with the scheme of directly transmitting information to all users subjected to the information service, but it is unclear whether or not the information is fully widely spread in practice. The technology disclosed in Patent Literature 2 evaluates the relationships with friends of a user in a community through, for example, a comment to a diary over an SNS (Social Networking Service), and can change the information to be presented. However, this technology focuses on only the transmission of the information through word-of-mouth communication to other users from a user whom the system has directly transmitted the information, and does not consider the information propagation route corresponding to whether or not the information is propagated further to other users. Moreover, the technology disclosed in Patent Literature 2 does not consider the difference in propagation route depending on the kind of the information, and may be effective for information of a type but may be possibly highly ineffective for information of other types. The technology disclosed in Patent Literature 3 controls the propagation of information only determined as good by a person having an appropriate judgment based on the degree of reliability of a person who provides the information, and does not consider the difference in propagation route depending on the kind of the information. The technology disclosed in Patent Literature 4 utilizes only the log of past propagation among the target users, and thus is unable to predict the level of propagation to the set of users having no past propagation log. Moreover, this technology also does not consider the difference in propagation route depending on the kind of the information. Likewise, the technology disclosed in Patent Literature 1 does not consider the difference in propagation route depending on the kind of the information.

When, for example, the information propagation among company members of a company is considered, job-related information like notification of a change in an intra-company system is propagated along the organization chart of the company, but information not related to the job but is related to a hobby is propagated along the relationships with friends among the company members. It is expected that if the job-related information is transmitted to the top of the company or the top of each organization, the information will be effectively propagated, but the same is not true of the information on hobbies. The conventional technologies which do not consider the difference in propagation route depending on the kind of the information are unable to present appropriate information transmission destinations for those two kinds of information.

The present invention has been made in view of the above-explained circumstances, and it is an object of the present invention to provide an information transmission support device, an information transmission support method, and a recording medium which can present a propagation network where an optimized propagation can be expected to a sender of information depending on the kind of the information.

### Means for Solving the Problems

An information transmission support device according to a first aspect of the present invention supports users to exchange information with one another via a communication network, and the information transmission support device includes:

a transmission-intended information obtaining means for obtaining transmission kind information indicating a kind of transmission-intended information to be transmitted to a user by an information sender;

a candidate propagation network obtaining means for searching and obtaining candidate propagation networks corresponding to the transmission kind information among propagation networks each comprising information on a sender user, a recipient user, a kind of information transmitted from the sender user to the recipient user, and a number, a probability, a time, or a combination thereof of transmission of the information of the kind from the sender user to the recipient user;

a recommended propagation network specifying means for obtaining, as a recommended propagation network, the candidate propagation network having a highest expected value of a total number of the users to whom information will be propagated within a predetermined time among the candidate propagation networks; and

a presenting means for presenting the recommended propagation network to the information sender.

An information transmission support method according to a second aspect of the present invention is for supporting users to exchange information with one another via a communication network, and the method includes:

a transmission-intended information obtaining step for obtaining transmission kind information indicating a kind of transmission-intended information to be transmitted to a user by an information sender;

a candidate propagation network obtaining step for searching and obtaining candidate propagation networks corresponding to the transmission kind information among propagation networks each comprising information on a sender user, a recipient user, a kind of information transmitted from the sender user to the recipient user, and a number, a probability, a time, or a combination thereof of transmission of the information of the kind from the sender user to the recipient user;

a recommended propagation network specifying step for obtaining, as a recommended propagation network, the candidate propagation network having a highest expected value of a total number of the users to whom information will be propagated within a predetermined time among the candidate propagation networks; and

a presenting step for presenting the recommended propagation network to the information sender.

A computer-readable recording medium according to a third aspect of the present invention has stored therein a program that allows a computer to execute:

a transmission-intended information obtaining step for obtaining transmission kind information indicating a kind of transmission-intended information to be transmitted to a user by an information sender;

a candidate propagation network obtaining step for searching and obtaining candidate propagation networks corresponding to the transmission kind information among propagation networks each comprising information on a sender user, a recipient user, a kind of information transmitted from the sender user to the recipient user, and a number, a probability, a time, or a combination thereof of transmission of the information of the kind from the sender user to the recipient user;

a recommended propagation network specifying step for obtaining, as a recommended propagation network, the candidate propagation network having a highest expected value of a total number of the users to whom information will be propagated within a predetermined time among the candidate propagation networks; and

a presenting step for presenting the recommended propagation network to the information sender.

### Effect of the Invention

According to the present invention, it becomes possible to present, to an information sender, a propagation network where the optimized information propagation can be expected in accordance with the kind of the information.

### BRIEF DESCRIPTION OF DRAWINGS

FIG. 1 is a block diagram showing an illustrative configuration of an information transmission support system according to a first embodiment of the present invention;

FIG. 2A is a graph showing an example time change in TF value of a word appropriate for keywords contained in transmission-target information, and FIG. 2B is a graph showing an example time change in TF value of a word not appropriate for keywords contained in the transmission-target information;

FIG. 3A is a diagram for explaining the kind information of a propagation network stored in an information DB according to the first embodiment, and FIG. 3B is a diagram for explaining the transmission record information of the propagation network stored in the information DB according to the first embodiment;

FIG. 4 is a flowchart showing an example operation of presenting a recommended propagation network according to the first embodiment;

FIG. 5A is a diagram for explaining link information contained in a propagation network stored in an information DB according to a second embodiment, and FIG. 5B is a diagram for explaining an information transfer rate contained in the propagation network stored in the information DB according to the second embodiment;

FIG. 6 is a diagram for explaining a data structure of user information stored in the information DB according to the second embodiment;

FIG. 7 is a block diagram showing an illustrative configuration of an information transmission support system according to a third embodiment of the present invention;

FIG. 8 is a flowchart showing an example operation of presenting a recommended propagation network according to the third embodiment;

FIG. 9 is a block diagram showing an illustrative hardware configuration of an information transmission support device according to an embodiment of the present invention;

FIG. 10 is a block diagram showing an illustrative configuration of an information transmission support device according to a modified example of the present invention; and

FIG. 11 is a block diagram showing an illustrative configuration of an information transmission support system according to a modified example of the present invention.

### MODE FOR CARRYING OUT THE INVENTION

In the following explanation, transmission-target information means information input into a sender terminal to be propagated from an information sender to users. Transmitted information is information transmitted by a user to another user, and is data like an electronic mail. A propagation network includes pieces of information on a sender user, a recipient user, a kind of information transmitted from the sender user to the recipient user, and the number, the probability, or the time or the combination thereof of transmission of the information of the kind from the sender user to the recipient user. The use of the propagation network enables a prediction of a probability of transmission of information of a kind from a user to another user. Moreover, when it is presumed that the number of transmission of information of a kind from the sender user to the recipient user is one and the probability is 100%, this information can be handled as a transmission record. That is, by tracing a link where information of a kind is transmitted, it becomes possible to generate transmission record information indicating a past transmission record of the propagation of the information.

For example, the propagation network includes kind information, transmission record information, link information, transfer rate information, and user information. The kind information is information indicating the kind of the already-transmitted information that is transmission-target information transmitted in past, and is expressed by keywords contained in the already-transmitted information for each already-transmitted information. The transmission record information is information indicating from which user, to which user and when the already-transmitted information transmitted in past was transmitted. The link information is information indicating the strength of the relationship between the users, and is set based on, for example, the number of transmitted information between the sender user and the recipient user. There are two kinds of the transfer rate information: information transfer rate indicating the probability of the transfer of the already-transmitted information; and a user transfer rate indicating the probability that a user transferred information to another user. The user information is information indicating an attribute of the user.

The above-explained definitions are to facilitate understanding of the present invention, and the present invention is not limited to such definitions. For example, the propagation network is optional as far as it indicates a propagation route of information of a kind.

Embodiments of the present invention will be explained in detail below with reference to the accompanying drawings.

### First Embodiment

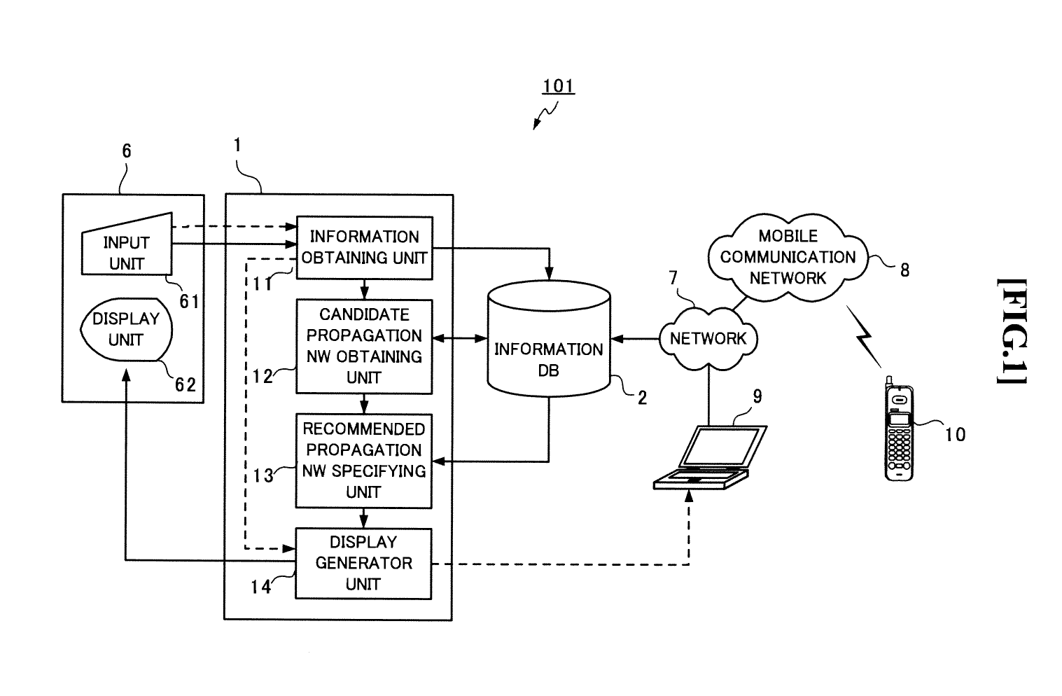

An information transmission support system 101 according to a first embodiment of the present invention includes, as shown in FIG. 1, an information transmission support device 1, an information database (hereinafter, referred to as an information DB) 2, a sender terminal 6, a user terminal 9 and a user terminal 10 through a network 7 and a mobile communication network 8 like the Internet. The information transmission support device 1 and the sender terminal 6 can communicate with each other via the network. The information DB 2 is communicatable with the user terminal 9 and the user terminal 10 via the network 7 and the mobile communication network 8, respectively, and stores information exchanged between the user terminals. The sender terminal 6 may be a part of the information transmission support device 1 or an attached device thereto. The information DB 2 may be built in the information transmission support device 1 or may be a plurality of databases. The two user terminals 9 and 10 are representatively illustrated in the figure, but equal to or greater than three user terminals may be connected to the network 7 or the mobile communication network 8.

The information transmission support device 1 includes an information obtaining unit 11, a candidate propagation NW obtaining unit 12, a recommended propagation NW specifying unit 13 and a display generator unit 14.

The information obtaining unit 11 receives the transmission-target information input by an information sender through the sender terminal 6. The information obtaining unit 11 extracts keywords of the transmission-target information, generates transmission kind information indicating the kind of the transmission-target information and stores the generated kind information in the information DB 2. Moreover, the information obtaining unit 11 transmits the transmission kind information to the candidate propagation NW obtaining unit 12. The transmission kind information may be input by the information sender through the sender terminal 6, and the information obtaining unit 11 may receive the transmission kind information from the sender terminal 6.

The candidate propagation NW obtaining unit 12 searches the propagation network of similar transmitted information with the same kind as that of the transmission-target information based on the transmission kind information received from the information obtaining unit 11 among propagation networks to be discussed later and stored in the information DB 2, and obtains a candidate propagation network that is the propagation network of the search result. For example, the candidate propagation NW obtaining unit 12 generates a plurality of keyword groups containing similar keywords for classifying information. When the kind is the same, it means a keyword contained in the information belongs to the same keyword group. Alternatively, the candidate propagation NW obtaining unit 12 may obtain the degree of similarity of keywords contained in the information received from the information obtaining unit 11 and the information stored in the information DB 2, and may determine that the kind is same when the degree of similarity is higher than a predetermined threshold. Moreover, the candidate propagation NW obtaining unit 12 transmits the candidate propagation network to the recommended propagation NW specifying unit 13.

The recommended propagation NW specifying unit 13 transmits the recommended propagation network to the display generator unit 14. The recommended propagation network is the candidate propagation network, among the candidate propagation networks received from the candidate propagation NW obtaining unit 12, having the highest expected value of the total number of users to whom information will be propagated within a predetermined time. When the predetermined time is sufficiently long, the higher the expected value of the total number of the users to whom information will be propagated within the predetermined time is, the candidate network will have a larger total number of users to whom the information will be actually propagated. Moreover, when the predetermined time is shorter than the validated period of the already-transmitted information (the limit of a period for storing the already-transmitted information), the higher the expected value of the total number of the users to whom the information will be propagated within the predetermined time is, the faster the propagation speed in the candidate propagation network is. Furthermore, the recommended propagation NW specifying unit 13 may transmit a plurality of candidate propagation networks to the display generator unit 14 as the recommended propagation networks in the order of the higher expected value of the total number of the users to whom the information will be propagated within the predetermined time.

The display generator unit 14 generates an image of displaying the recommended propagation network received from the recommended propagation NW specifying unit 13, and transmits the generated image to the sender terminal 6. When accepting the presented recommended propagation network, the information sender himself/herself may transmit the transmission-target information to initial users, or may cause the information transmission support device 1 to transmit the transmission-target information. In the latter case, the information sender inputs a transmission instruction through an input unit 61 to the presented recommended propagation network. The information obtaining unit 11 receives the transmission instruction from the input unit 61, and transmits such an instruction to the display generator unit 14. Upon reception of the transmission instruction, the display generator unit 14 transmits the transmission-target information to the user terminal (in FIG. 1, the user terminal 9) of the initial user. The flow of the transmission instruction is indicated by an arrow of dashed lines in FIG. 1. Alternatively, the display generator unit 14 may automatically transmit the transmission-target information to the user terminals of the initial users of the recommended propagation network upon reception of the recommended propagation network from the recommended propagation NW specifying unit 13. Moreover, the display generator unit 14 may generate not the image displaying the recommended propagation network but, for example, text information, and may transmit the generated text information to the sender terminal 6. That is, it is satisfactory if the display generator unit 14 visualizes the recommended propagation network in a form that enables the information sender to recognize it and the way of visualization is not limited to any particular one.

The information DB 2 stores the propagation network generated for each information already transmitted in the past. The propagation network is generated based on the transmitted information transmitted by the user in the past via the communication network. Moreover, the information DB 2 may store the propagation network every time information is transmitted, may obtain transmitted information intermittently, and may store the propagation network based on such information.

The sender terminal 6 includes the input unit 61 and a display unit 62. The input unit 61 receives inputting of the transmission-target information given by the information sender. The display unit 62 displays the image transmitted from the display generator unit 14 of the information transmission support device 1.

Next, an explanation will be given in detail of an operation when the information obtaining unit 11 extracts keywords. The information obtaining unit 11 determines the kind of the transmission-target information received from the sender terminal 6, and generates the transmission kind information. The transmission kind information can be expressed as, for example, a combination of several important words (keywords) contained in the transmission-target information. The word to be the keyword is extracted from the pieces of transmitted information (e.g., pieces of data of electronic mails) of all users using the information transmission support system 101 which are stored in the information DB 2. An example way of deciding the keyword is a TF-IDF technique (TF: Term Frequency, IDF: Inverse Document Frequency). The TF-IDF technique is a conventionally well-known algorithm for extracting distinctive words (words deemed as important) from a text.

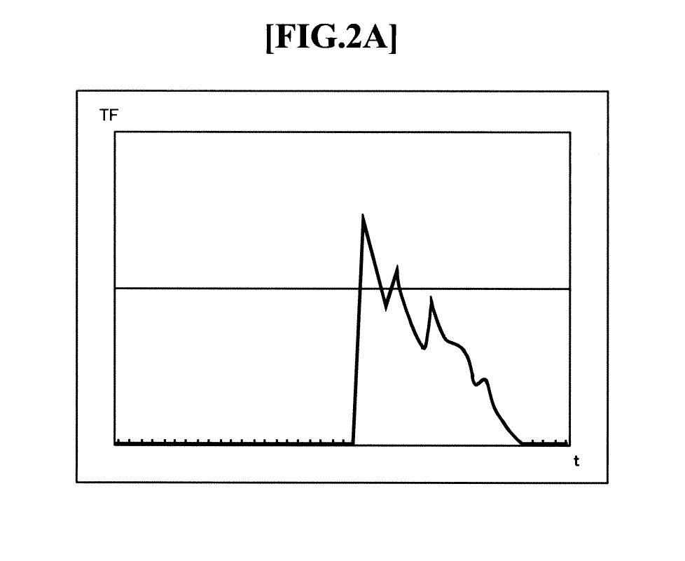

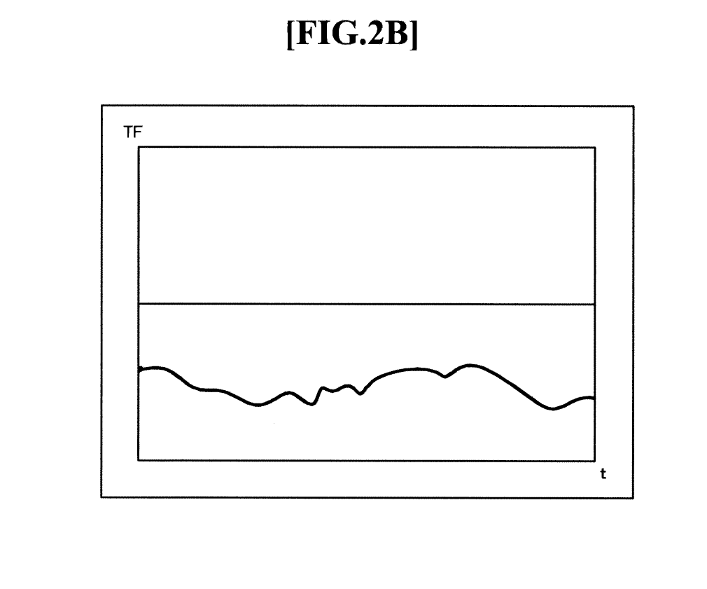

It is appropriate if the word to be the keyword be a word having a TF value becoming high during a certain period as shown in FIG. 2A among the words contained in the transmitted information by the user. This is because the word having the TF value becoming high during the certain period is possibly not a word used on a daily basis but a word becoming a popular topic of conversation and propagated in a certain period. Conversely, the word having the TF value with a little change as shown in FIG. 2B is possibly a word used on a daily basis, and is not suitable as the keyword. The keyword extracted in this manner is a feature of the transmitted information where the keyword is extracted.

The information obtaining unit 11 extracts the keywords contained in the transmission-target information as explained above, generates the transmission kind information, and transmits the generated transmission kind information to the candidate propagation NW obtaining unit 12. The candidate propagation NW obtaining unit 12 searches the propagation network of similar transmitted information containing the keyword consistent with or similar to the keyword contained in the transmission kind information, and obtains the candidate propagation network.

Next, a detailed explanation will be given of the propagation network. The propagation network includes the kind information, and the transmission record information, etc., and is generated by extracting the transmitted information containing the keyword from among the pieces of transmitted information stored in the information DB 2, and based on the contents of the already-transmitted information, a transmission time and sender/recipient users.

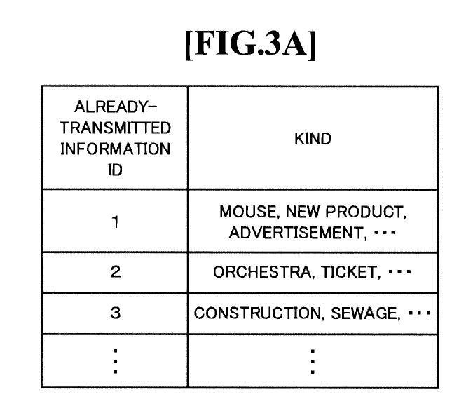

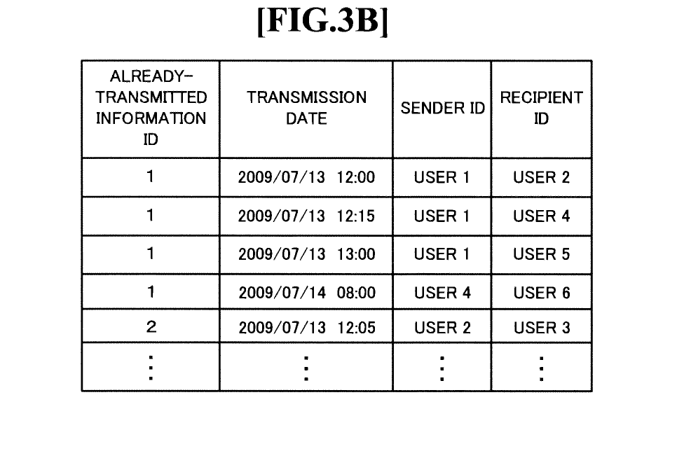

As shown in FIG. 3A, the kind information is a data table which represents the kinds of already-transmitted information transmitted in the past and contains the fields of “already-transmitted information ID” for identifying the already-transmitted information and “kind” indicating the keyword contained in the already-transmitted information.

As shown in FIG. 3B, the transmission record information is a data table indicating from which user, to which user, and when the already-transmitted information transmitted in the past was transmitted, and contains the fields of “already-transmitted information ID” for identifying the already-transmitted information, “transmission date” indicating the date of transmission, “sender ID” indicating a sender user, and “destination ID” indicating a recipient user. The information DB 2 stores such propagation networks for all already-transmitted information transmitted in the past.

Next, with reference to FIG. 3A, an explanation will be given of a method of obtaining the candidate propagation network according to the first embodiment. It is presumed that, for example, the keyword contained in the transmission-target information input by the information sender through the input unit 61 of the sender terminal 6 is “personal computer”. In this case, an already-transmitted information ID 1 (similar transmitted information) containing “mouse, new product, advertisement, etc.,” including the keyword “mouse” which is an equipment of the “personal computer” and which has a high degree of similarity is extracted as a search result. With respect to the two similar keywords, the group of people interested in the “personal computer” and the group of people interested in the “mouse” are similar, and respective user constructions belonging to such groups are also similar, and thus respective propagation networks can be similar. Hence, the candidate propagation NW obtaining unit 12 obtains the propagation network of the already-transmitted information ID 1 as the candidate propagation network. The degree of similarity between the keywords is obtained through, for example, an association degree calculation using thesaurus, but the present invention is not limited to this technique, and for example, a conventionally well-known technique like a cosine similarity degree may be applied to obtain the degree of similarity. For example, the candidate propagation NW obtaining unit 12 sets the threshold for the degree of similarity, and takes the propagation network of the similar transmitted information having the degree of similarity higher than the threshold as the candidate propagation network. The similar transmitted information includes ones which contain not only the similar keyword to the keyword contained in the transmission-target information but also partially matching or completely matching keyword.

Next, an explanation will be given of a method of obtaining the recommended propagation network according to the first embodiment with reference to FIG. 3B. For example, it is presumed that the propagation network of the already-transmitted information ID 1 is the candidate propagation network, and the predetermined time is “20 hours”. When a user 1 is the initial user to whom the transmission-target information will be directly transmitted, the recommended propagation NW specifying unit 13 predicts that the transmission-target information will be transmitted from the user 1 to users 2, 4, and 5, and from the user 4 to a user 6. Likewise, the recommended propagation NW specifying unit 13 predicts the propagation of the transmission-target information for all candidate propagation networks obtained by the candidate propagation NW obtaining unit 12. Next, the recommended propagation NW specifying unit 13 transmits the candidate propagation network having the highest expected value of the total number of the users to whom information will be propagated within the predicted predetermined time to the display generator unit 14 as the recommended propagation network. When the similar transmitted information of the candidate propagation network has the high degree of similarity, it can be expected that information will be propagated in practice like the candidate propagation network, but when the degree of similarity is low, there is a possibility that the number of the users to whom information will be actually propagated becomes lower than that of the candidate propagation network. Hence, the recommended propagation NW specifying unit 13 may obtain, when obtaining the expected value of the total number of the users to whom information will be propagated within the predetermined time in each predicted candidate propagation network, the expected value by multiplying a coefficient in accordance with the degree of similarity.

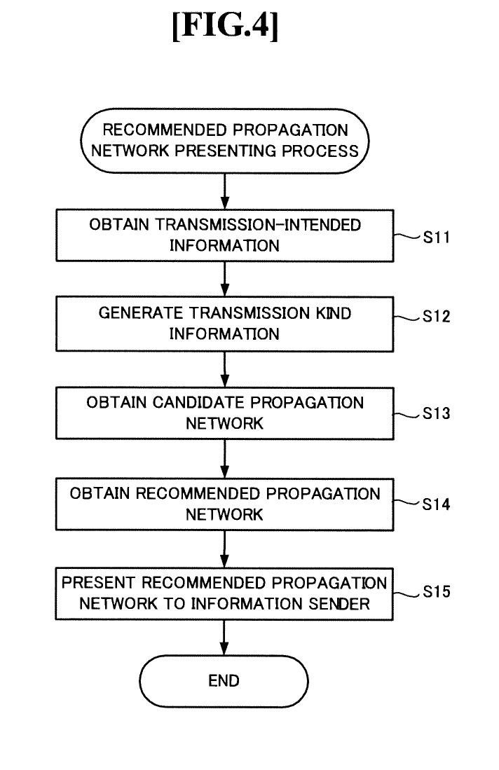

The information transmission support device 1 in the above-explained information transmission support system 101 operates as shown in FIG. 4. When the transmission-target information is input through the sender terminal 6, the information transmission support device 1 starts a recommended propagation network presenting process. First, the information obtaining unit 11 obtains the transmission-target information from the sender terminal 6 (step S11). The information obtaining unit 11 extracts the keyword of the transmission-target information, generates the transmission kind information, and transmits the generated transmission kind information to the candidate propagation NW obtaining unit 12 (step S12). The candidate propagation NW obtaining unit 12 obtains, as the candidate propagation networks, the propagation networks of the pieces of similar transmitted information containing the matching or similar keyword based on the transmission kind information from the information DB 2 (step S13). Next, the recommended propagation NW specifying unit 13 predicts the expected value of the total number of the users to whom information will be propagated within the predetermined time for each candidate propagation network, and obtains the candidate propagation network having the highest expected value of the predicted total number as the recommended propagation network (step S14). The display generator unit 14 transmits the recommended propagation network to the sender terminal 6 to present the recommended propagation network to the information sender (step S15), and terminates the process.

When the information DB 2 does not store the propagation network of the similar transmitted information containing the matching or similar keyword as that of the transmission kind information (a search result is inconsistent), the candidate propagation NW obtaining unit 12 may obtain no candidate propagation network and terminate the process in the step S13.

As explained above, according to the information transmission support system 101 of the first embodiment, it becomes possible to present, to the information sender, the propagation network having the highest expected value of the total number of the users to whom it is predicted that information will be propagated within the predetermined time in accordance with the kind of the information. Moreover, by selecting the initial user of the optimized propagation network and transmitting information thereto in accordance with the contents of the information to be transmitted, not by selecting the initial user at random, an effective propagation can be expected.

### Second Embodiment

An information transmission support system according to a second embodiment of the present invention employs the same configuration as that of the information transmission support system 101 of the first embodiment shown in FIG. 1. According to the second embodiment, the information DB 2 stores, as the propagation network, in addition to the kind information and the transmission record information, link information indicating the strength of relationships among the users, transfer rate information indicating the transfer probability, and user information. The recommended propagation NW specifying unit 13 obtains the recommended propagation network based on the link information, the transfer rate information and the user information. Moreover, the information DB 2 stores the user information of each user. According to the second embodiment, the information DB 2 stores, in the transfer rate information, an information transfer rate added to the kind information and a user transfer rate added to the user information.

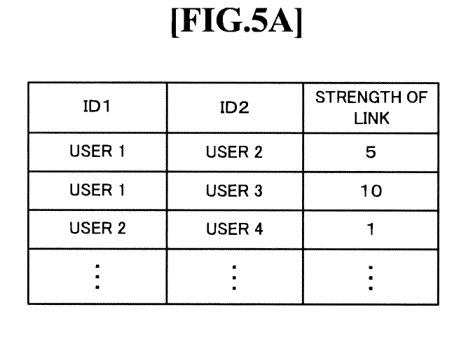

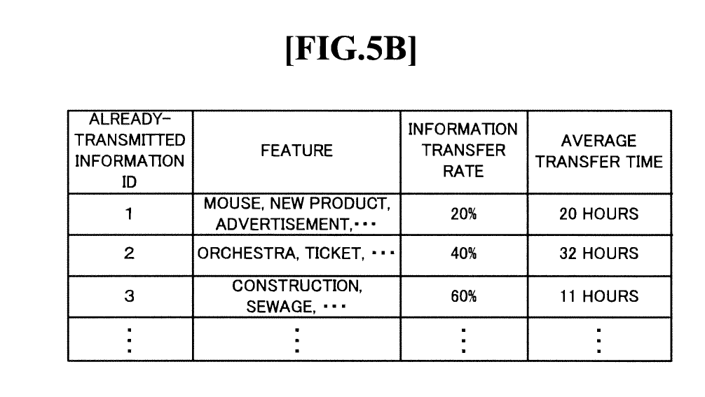

As shown in FIG. 5A, the information DB 2 stores the link information. The link information is a data table indicating the strength of relationships among the users, and contains the fields of “user ID 1” and “user ID 2” for identifying both users with a relationship, and “strength of link” indicating the strength of a relationship. The “strength of link” may be obtained by, for example, utilizing the transmission record information to obtain the number of mails exchanged between the users, or may be input by the user himself/herself.

Moreover, as shown in FIG. 5B the information DB 2 stores the information transfer rate. The information transfer rate is information indicating the probability that the already-transmitted information is transferred, and in the example case shown in FIG. 5B, the information transfer rate is added to the kind information shown in FIG. 3A as a field indicating the probability that the already-transmitted information is transferred. Furthermore, in the example case shown in FIG. 5B, the kind information has a field of “average transfer time” indicating an average time until the already-transmitted information is transferred after being transmitted. The information transfer rate is obtained based on the transmission record information, and is obtained as, for example, the percentage of the users, among the users who have received the transmitted information containing the keywords “mouse, new product, advertisement, etc.,” also contained in the already-transmitted information of the already-transmitted information ID 1, who transferred such information to another user The information transfer rate largely changes even in the same user group depending on the kind of the information to be propagated. For example, in the case of an information propagation among residents in a community, information that a large number of community residents pay attention to like information on a sewerage work carried out in that local area, has a high information transfer rate. However, information that is not related to the community and people interested at that information are, like information on the new product of a mouse of a personal, has a low information transfer rate since a person does not transfer such information even if such a person received such information because of the lack of interest, or a person does not know another person who is interested in such information even though the former person was interested in such information.

Next, with reference to FIGS. 3B, 5A, and 5B, an explanation will be given of an example case in which the recommended propagation NW specifying unit 13 predicts the propagation network based on the link information and/or the information transfer rate.

In the transmission record information shown in FIG. 3B, the initial user to whom the already-transmitted information ID 1 is initially transmitted is the user 1, and the user 1 transmits the already-transmitted information ID 1 to the users 2, 4, and 5 (total: three people). The user 1 does not transmit the already-transmitted information ID 1 to the user 3, but with reference to FIG. 5A, there is a link with a strength of 10 between the user 1 and the user 3. Accordingly, the recommended propagation NW specifying unit 13 predicts that the user 1 will transmit the transmission-intended information to the user 3 at the probability of a middle level. At this time, the recommended propagation NW specifying unit 13 obtains the number of users to whom the transmission-intended information will be transmitted from the user 1 who is the initial user as 3+0.5=3.5 people.

Moreover, when the user 3 has a user 7 having a link therewith at a strength of 10, the recommended propagation NW specifying unit 13 predicts that the user 3 will transmit the transmission-intended information to the user 7 at the probability of a middle level. At this time, the recommended propagation NW specifying unit 13 obtains the number of users to whom the transmission-intended information will be transmitted from the user 3 as 0.5×0.5=0.25 people. A level (e.g., a link strength of 10=a middle level) of a propagation proportional to the strength of the link, a value for evaluating the level of transmission from the initial user to another user (e.g., a middle level=0.5 people) by the number of the users, and a value for evaluating the level of transmission from a user to whom the initial user transmitted information to further other user by the number of the users (e.g., a middle level×a middle level=0.5×0.5=0.25 people) may be freely set by the information sender, or may be set in advance. The recommended propagation NW specifying unit 13 obtains, for users not on the transmission record information, the number of users to whom information will be propagated within the predetermined time based on the “average transfer time” in the kind information, adds the obtained number with the number of the users to whom the information will be propagated within the predetermined time from the user in the transmission record information, and transmits, as the recommended propagation network, the candidate propagation network having the highest expected value of such a total number to the display generator unit 14.

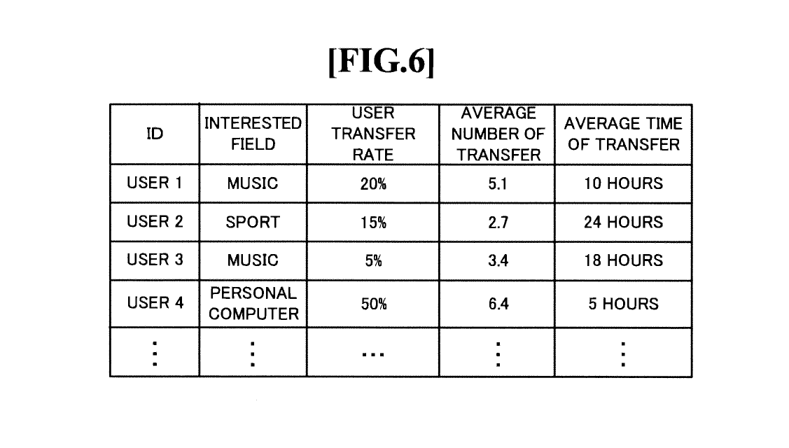

Moreover, as shown in FIG. 6, the information DB 2 stores the user information. In the example case shown in FIG. 6, the user transfer rate is added to the user information as a field of “user transfer rate” indicating the probability that the user will transfer information to another user.

The user information is a data table indicating the attributes of the user, and includes fields of “ID” for identifying the user, “interest field” indicating a field in which the user is interested, “user transfer rate” indicating the probability that the user will transfer information to another user, “average transfer number” indicating the average value of the number of people to whom information is transferred when the user transferred the information, and “average transfer time” indicating an average time until information is transferred after the user received such information in the case in which the user transfers such information. The user transfer rate largely changes depending on the character of the user, and the user group where the user belongs. When, for example, a user has an active character of transmitting information to another person, or belongs to a user group where information exchange is active, the user transfer rate of such a user becomes high.

Next, with reference to FIG. 6, an explanation will be given of an example case in which the recommended propagation NW specifying unit 13 predicts the propagation network based on the user information and the user transfer rate. For example, it is presumed that the information sender inputs the transmission-intended information containing a keyword “personal computer” through the sender terminal 6. The candidate propagation NW obtaining unit 12 refers to the user information, and extracts the user “user 4” who is interested in the “personal computer”. The recommended propagation NW specifying unit 13 refers to the “user transfer rate” and the “average transfer number” of the “user 4”, and predicts that if the transmission-intended information is transmitted to the user 4 as the initial user, such information will be transferred to 6.4 (the average transfer number)×0.5 (the user transfer rate)=3.2 users. Next, the recommended propagation NW specifying unit 13 refers to the link information and the user information, and predicts that the interest field is the “personal computer” and the user 4 will transmit the transmission-intended information to upper three users with strong relationships with the user 4. The number of decimals may be rounded, or the fourth user may be obtained as 0.2 people.

Such prediction is repeated and the recommended propagation NW specifying unit 13 predicts the propagation network when the user 4 is the initial user. As explained above, the recommended propagation NW specifying unit 13 predicts each propagation network when each user interested in the “personal computer” extracted by the candidate propagation NW obtaining unit 12 referring to the user information is the initial user. Moreover, the recommended propagation NW specifying unit 13 obtains the expected value of the total number of the users to whom information will be propagated within the predetermined time based on the “average transfer time” in the user information, and the candidate propagation network having the highest expected value is transmitted to the display generator unit 14 as the recommended propagation network.

In this example, the recommended propagation NW specifying unit 13 multiplies the “user transfer rate” by the “average transfer number” to predict the number of other users to whom information will be propagated from the user. However, the present invention is not limited to this operation, and the recommended propagation NW specifying unit may refer to the transmission record information, and may create an approximation formula for obtaining the number of users to whom information will be propagated from the user based on the values of the “user transfer rate” and the “average transfer number” to predict the number of users. Moreover, the recommended propagation NW specifying unit may refer to the kind information shown in FIG. 3A and the transmission record information shown in FIG. 3B, and may predict the number of users to whom information will be propagated from the user based on the sender user, the recipient user, the kind of information transmitted from the sender user to the recipient user, and the number of transmissions from the sender user to the recipient user of the same kind of information or a time difference between the received time and the transmitted time.

Moreover, the information sender may input target attribute information indicating the attribute of the user to whom the information sender wants to send the transmission-intended information through the sender terminal 6. The information obtaining unit 11 receives the target attribute information, and transmits the received information to the recommended propagation NW specifying unit 13. When, for example, the transmission-intended information is information for male and female in their 20s, the information sender inputs the target attribute information intended for the users having the user information containing the field “age” that is 20s. Moreover, when the transmission-intended information is information for TOKYO only, the information sender inputs the target attribute information intended for the users having the user information containing the field “area” that is TOKYO.

Conversely, the candidate propagation NW obtaining unit 12 transmits the candidate propagation network obtained from the information DB 2 to the recommended propagation NW specifying unit 13. The recommended propagation NW specifying unit 13 refers to the user information, and obtains, as the recommended propagation network, the candidate propagation network having the highest expected value of the total number of the users having the user information matching with the target attribute information among the users to whom information will be propagated within the predetermined time. That is, the recommended propagation NW specifying unit 13 evaluates the candidate propagation network based on the number of the effective users to whom the transmission-intended information will be propagated.

As explained above, according to the information transmission support system 101 of the second embodiment, as the propagation network, the recommended propagation network is obtained based on the link information, the transfer rate information and the user information in addition to the kind information and the transmission record information, the propagation prediction can have a higher precision. Moreover, with respect to the users not in the transmission record information, it is possible to predict the propagation network. Furthermore, by evaluating the candidate propagation network in consideration of the target attribute information and the user information, a further optimized recommended propagation network can be presented to the information sender.

### Third Embodiment

As shown in FIG. 7, an information transmission support system 102 according to a third embodiment of the present invention employs a configuration in which an information transmission support device 3 has a setting unit 15 in addition to the configuration of the information transmission support system 101 of the first embodiment. According to the third embodiment, the setting unit 15 sets a predetermined time when the recommended propagation NW specifying unit 13 obtains the expected value of the total number of the users to whom information will be propagated in the candidate propagation network, and the number of initial users indicating the number of users to whom the transmission-intended information is directly transmitted or the number of propagated users indicating the total number of the users to whom information will be propagated. In the following explanation, a structural element denoted by the same reference numeral as that of the information transmission support system 101 of the first embodiment operates the same as that of the information transmission support system 101 of the first embodiment.

First, the information sender inputs the transmission-intended information that the information sender wants to transmit through the input unit 61 of the sender terminal 6. At this time, a predetermined time for causing the transmission-intended information to be propagated is input as setting information. When, for example, the transmission-intended information relates to an event a week after, the information needing more than a week to be propagated is not effective for the users, and thus the information sender inputs “one week” as the predetermined time for predicting the propagation network. The predetermined time “one week” input by the information sender through the input unit 61 is transmitted to the information transmission support device 3, and the information obtaining unit 11 receives this information. The information obtaining unit 11 transmits the predetermined time “one week” to the setting unit 15, and the setting unit 15 sets a time for predicting the propagation network to be “one week” to the recommended propagation NW specifying unit 13. The recommended propagation NW specifying unit 13 obtains the expected value of the total number of the users to whom the information will be propagated within one week for each candidate propagation network obtained by the candidate propagation NW obtaining unit 12, and obtains, as the recommended propagation network, the candidate propagation network having the highest expected value of the total number.

Likewise, the information sender inputs the number of initial users, or the total number of the users to whom the information sender wants to propagate information as the setting information through the input unit 61. For example, when the available costs to transmit the transmission-intended information is limited, if the cost for each initial user is set, the number of the initial users can be fixed, and thus the information sender inputs the fixed number of initial users. Conversely, when the number of the users to whom the information sender wants to provide the transmission-intended information is already decided, the information sender inputs the number of the users to whom information will be propagated.

An explanation will be given of an example case in which the information sender inputs the number of initial users. The information sender inputs, as the number of initial users, “10 people”. The number of initial users “10 people” input by the information sender through the input unit 61 is transmitted to the information transmission support device 3, and the information obtaining unit 11 receives the number of initial users “10 people”. The information obtaining unit 11 transmits the number of initial users “10 people” to the setting unit 15, and the setting unit 15 sets the number of initial users to be “10 people” to the recommended propagation NW specifying unit 13. The recommended propagation NW specifying unit 13 obtains, as the recommended propagation network, a combination of the candidate propagation networks having the number of initial users that is “10 people” and the highest expected value of the total number of the users to whom information will be propagated within the predetermined time (e.g., “one week”) among the candidate propagation networks obtained by the candidate propagation NW obtaining unit 12.

An explanation will be given of an example case in which the information sender inputs the total number of the users to whom the information sender wants to propagate information. The information sender inputs “100 people” as the number of the users to whom information will be propagated. The number of the users “100 people” to whom information will be propagated and input by the information sender through the input unit 61 is transmitted to the information transmission support device 3, and the information obtaining unit 11 receives the number of the users “100 people” to whom information will be propagated. The information obtaining unit 11 transmits the number of the users “100 people” to whom information will be propagated to the setting unit 15, and the setting unit 15 sets the number of the users to whom information will be propagated to be “100 people” to the recommended propagation NW specifying unit 13. The recommended propagation NW specifying unit 13 obtains, among the candidate propagation networks obtained by the candidate propagation NW obtaining unit 12, a combination of the candidate propagation networks having the expected value of the total number of the users to whom information will be propagated within the predetermined time (e.g., “one week”) which is “100 people” and having the smallest number of the initial users as the combination of the recommended propagation networks.

For the candidate propagation network obtained by the candidate propagation NW obtaining unit 12, when obtaining the expected value of the total number of the users to whom information will be propagated, the recommended propagation NW specifying unit 13 may obtain duplicated users as a user. This is because the “substantive value” of the expected value of the total number of the users to whom information will be propagated is important for the information sender, not the “total value” of such an expected value, and when the same information will be transmitted from the plurality of users, in comparison with a case in which the information is derived from only one person, the users are not likely to feel the importance of the information. The “substantive value” of the expected value of the total number of the users to whom information will be propagated is referred to as a “pure total number of the users to whom information will be propagated”.

Moreover, the setting unit 15 may automatically set the predetermined time, the number of the initial users, and the number of the users to whom information will be propagated appropriate for the transmission-intended information based on the propagation networks like the transmission record information stored in the information DB 2.

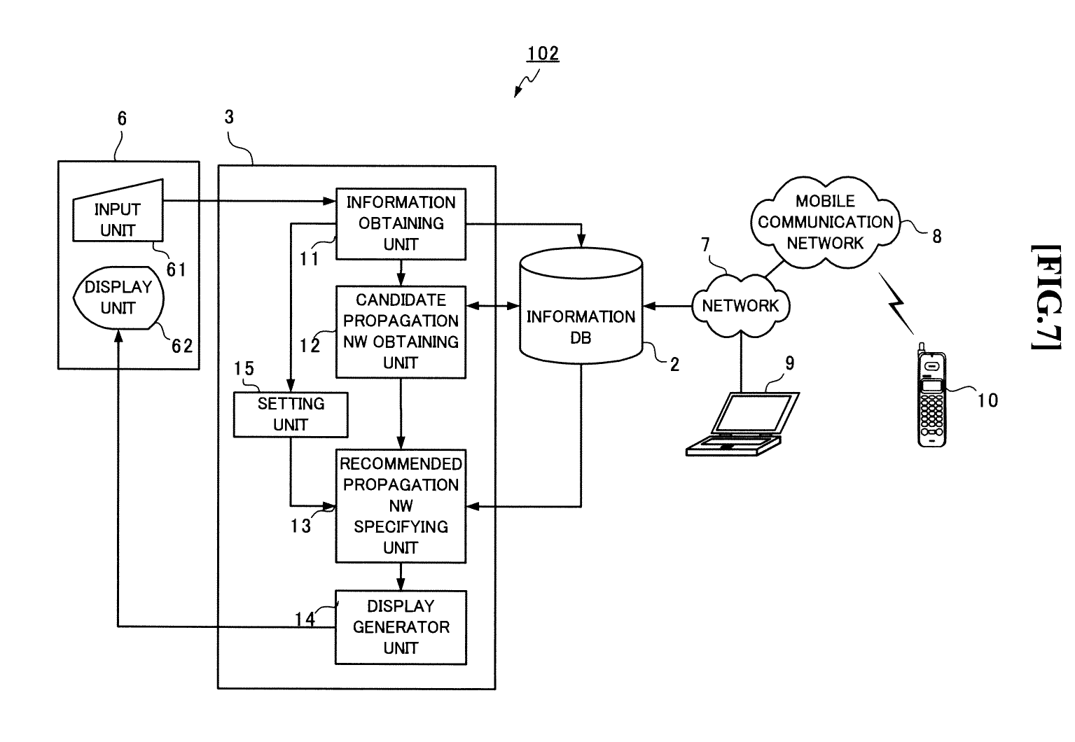

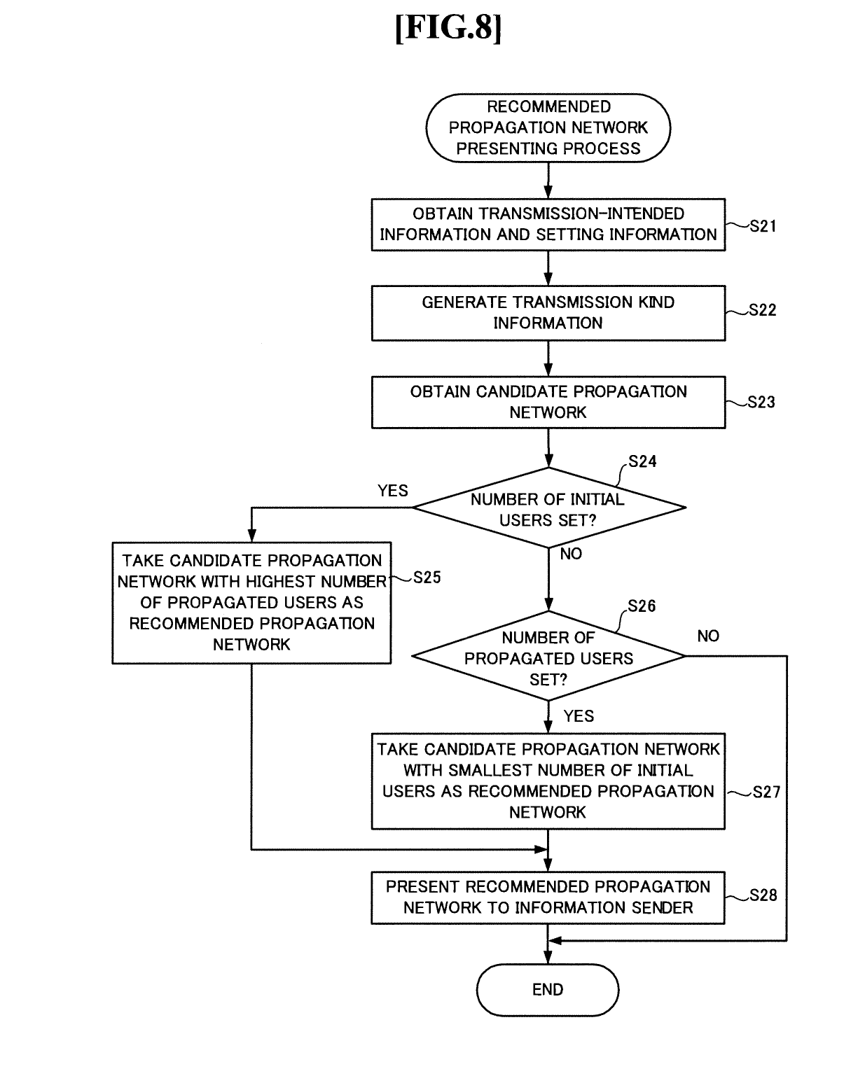

The above-explained information transmission support device 3 of the information transmission support system 102 operates as shown in FIG. 8. When the transmission-intended information and the setting information are input through the sender terminal 6, the information transmission support device 3 starts a recommended propagation network presenting process. First, the information obtaining unit 11 obtains the transmission-intended information and the setting information from the sender terminal 6 (step S21). The information obtaining unit 11 extracts a keyword of the transmission-intended information, generates the transmission kind information, and transmits the generated information to the candidate propagation NW obtaining unit 12 (step S22). The candidate propagation NW obtaining unit 12 obtains the propagation network of the similar transmitted information containing the matching or similar keyword from the information DB 2 as the candidate propagation network based on the transmission kind information (step S23).

When the setting information for setting the number of the initial users is obtained in the step S21 (step S24: YES), the recommended propagation NW specifying unit 13 obtains, as the recommended propagation network, a combination of the candidate propagation networks which is the combination of the candidate propagation networks with the set number of the initial users, and which has the maximum expected value of the pure total number of the users to whom information will be propagated within the predetermined time (step S25). The display generator 14 transmits the recommended propagation network to the sender terminal 6 to present the recommended propagation network to the information sender (step S28), and terminates the process. When no setting information for setting the number of the initial users is obtained in the step S21 (step S24: NO), but the setting information for setting the number of the users to whom information will be propagated is obtained (step S26: YES), the recommended propagation NW specifying unit 13 obtains, as the recommended propagation network, a combination of the candidate propagation networks which is for propagating information to the set number of the users to whom the information will be propagated and which has the minimum number of the initial users (step S27). The display generator unit 14 transmits the recommended propagation network to the sender terminal 6 to present the recommended propagation network to the information sender (step S28), and terminates the process.

When, in the step S23, the information DB 2 stores no propagation network of similar transmitted information containing the matching or similar keyword to the transmission kind information (a search result is inconsistent), the candidate propagation NW obtaining unit 12 may terminate the process without obtaining the candidate propagation network.

As explained above, according to the information transmission support device 102 of the third embodiment, it becomes possible to present, to the information sender, the combination of the propagation networks having the highest expected value of the total number of the users to whom it is predicted that information will be propagated within the predetermined time under the condition set by the information sender. Moreover, obtaining duplicate users as one user, it becomes possible to obtain the combination of the propagation networks having the highest expected value of the pure total number of the users to whom information will be propagated, and the combination of the propagation networks further optimized for the information sender can be presented thereto.

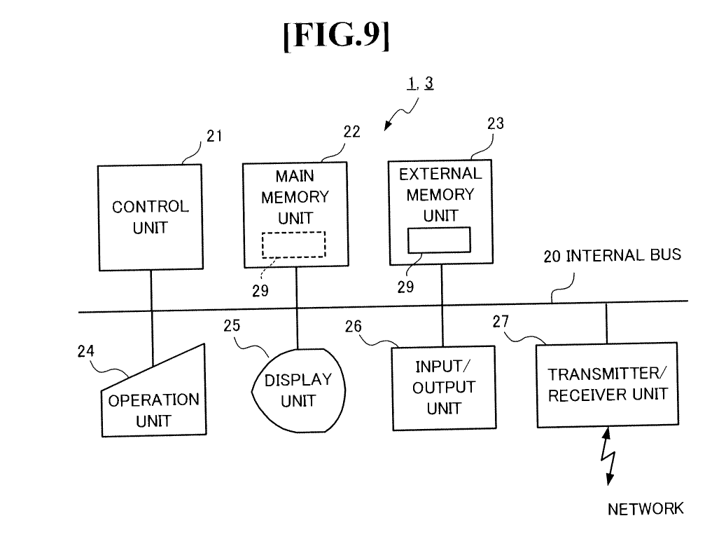

Next, an explanation will be given of a hardware configuration of the information transmission support device according to the embodiments of the present invention. The information transmission support device 1 or 3 includes, as shown in FIG. 9, a control unit 21, a main memory unit 22, an external memory unit 23, an operation unit 24, a display unit 25, an input/output unit 26 and a transmitter/receiver unit 27. The main memory unit 22, the external memory unit 23, the operation unit 24, the display unit 25, the input/output unit 26, and the transmitter/receiver unit 27 are all coupled with the control unit 21 via an internal bus 20.

The control unit 21 includes a CPU (Central Processing Unit), etc., and executes respective processes of the information obtaining unit 11, the candidate propagation NW obtaining unit 12, the recommended propagation NW specifying unit 13, the display generator unit 14, and the setting unit 15 of the information transmission support device 1 or 3 in accordance with a control program 29 stored in the external memory unit 23.

The main memory unit 22 includes a RAM (Random-Access Memory), etc., loads therein the control program 29 stored in the external memory unit 23, and is used as a work area for the control unit 21.

The external memory unit 23 includes a non-volatile memory, such as a flash memory, a hard disk, a DVD-RAM (Digital Versatile Disc Random-Access Memory), or a DVD-RW (Digital Versatile Disc ReWritable), stores in advance the program for causing the control unit 21 to execute the above-explained processes, supplies data stored with the program to the control unit 21 in response to an instruction from the control unit 21, and stores data supplied from the control unit 21. The information DB 2 is configured by the external memory unit 23.

The operation unit 24 includes pointing devices like a keyboard and a mouse, and an interface device that connects the keyboard and the pointing device, etc., to the internal bus 20. When the predetermined time, the number of the users to whom information will be propagated, and the number of the initial users, etc., are directly set not via the network, an instruction is supplied to the control unit 21 through the operation unit 24. When the sender terminal 6 shown in FIG. 1 or 7 is included in the information transmission support device 1 or 3, the operation unit 24 may serve as the input unit 61.

The display unit 25 includes an organic EL (Electro Luminescence) or an LCD (Liquid Crystal Display), etc., and when the predetermined time, the number of the users to whom information will be propagated, and the number of the initial users, etc., are directly set not via the network, the display unit displays an operation screen. When the sender terminal 6 shown in FIG. 1 or 7 is included in the information transmission support device 1 or 3, the display unit 25 may serve as the display unit 62.

The input/output unit 26 includes a serial interface or a parallel interface. The input/output unit 26 is, when the sender terminal 6 is an accompanying device, coupled therewith.

The transmitter/receiver unit 27 includes a network end terminal device or a wireless communication device connected to the network, and a serial interface or a LAN (Local Area Network) interface connected to the former device. The transmitter/receiver unit 27 is connected to the sender terminal 6, the user terminal 9, and the user terminal 10 via the network.

Respective processes of the information obtaining unit 11, the candidate propagation NW obtaining unit 12, the recommended propagation NW specifying unit 13, the display generator unit 14, and the setting unit 15 of the information transmission support device 1 or 3 shown in FIG. 1 or 7 are executed by the control program 29 that uses the resources, such as the control unit 21, the main memory unit 22, the external memory unit 23, the operation unit 24, the display unit 25, the input/output unit 26, and the transmitter/receiver unit 27.

### Modified Example

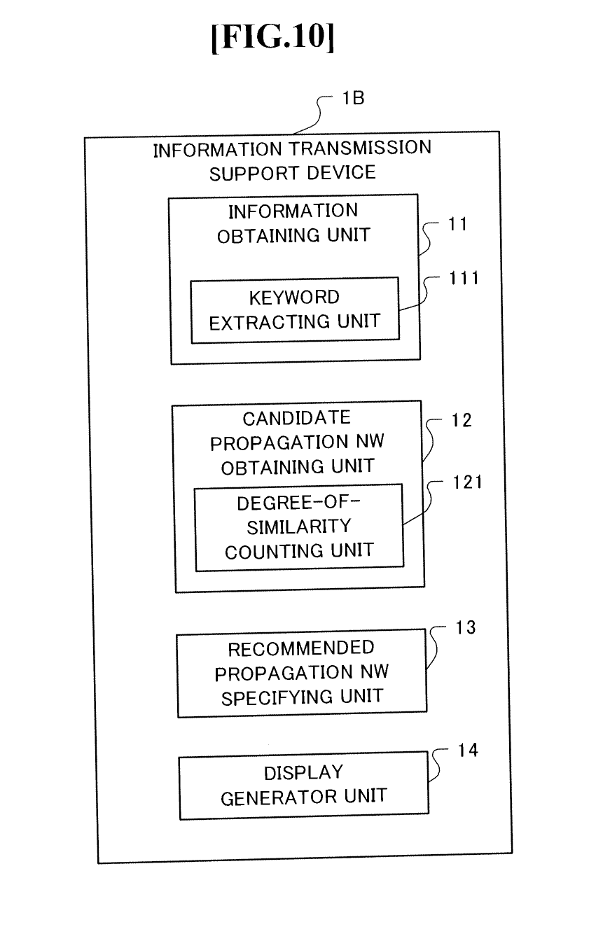

The present invention is not limited to the above-explained embodiments, and can be changed and modified in various forms. As shown in FIG. 10, the information transmission support device of the present invention may employ a configuration in which the information obtaining unit 11 includes a keyword extracting unit 111, and the candidate propagation NW obtaining unit 12 includes a degree-of-similarity counting unit 121.

When such a configuration is employed, the keyword extracting unit 111 extracts a keyword from the transmission-intended information received from the sender terminal 6. Moreover, the degree-of-similarity counting unit 121 obtains the degree of similarity between the keyword of the propagation network stored in the information DB 2 and the keyword contained in the transmission kind information received from the information obtaining unit 11.

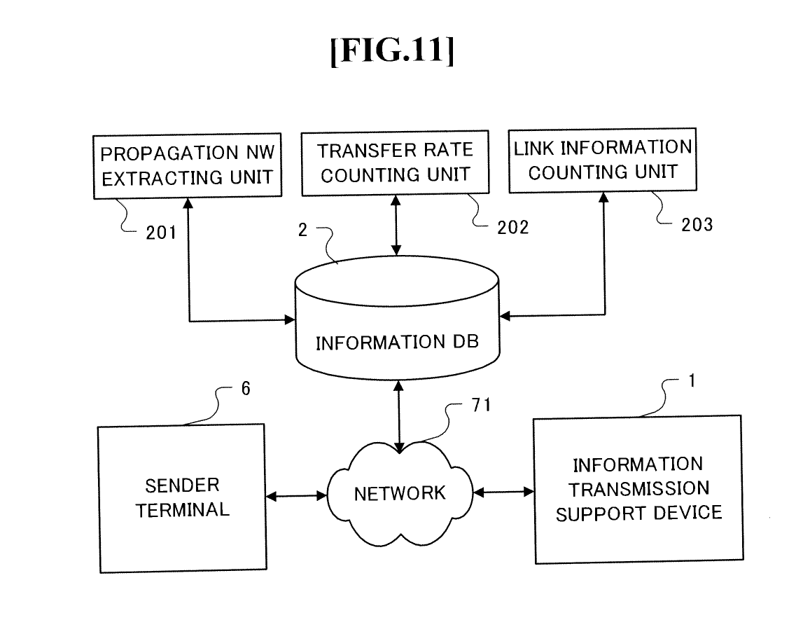

The information transmission support system of the present invention may employ a configuration in which, as shown in FIG. 11, the information transmission support device 1, the sender terminal 6, and the information DB 2 can communicate with one another via a network 71. Moreover, a propagation NW extracting unit 201, a transfer rate counting unit 202 and a link information counting unit 203 which can communicate with the information DB 2 may be further provided. According to this configuration, the propagation NW extracting unit 201, the transfer rate counting unit 202, and the link information counting unit 203 are optional as far as those units can communicate with the information DB 2, and the information transmission support device 1 may have the above-explained structural elements, or the sender terminal 6 may have those structural elements.

When such a configuration is employed, the propagation NW extracting unit 201 extracts the propagation network from the transmitted information stored in the information DB 2, and stores the extracted propagation network in the information DB 2. Moreover, the propagation NW extracting unit 201 extracts the propagation network from, when, for example, the transmitted information is an electronic mail, the header of the electronic mail, and stores the extracted propagation network in the information DB 2. However, the present invention is not limited to this operation, and as far as the propagation network can be extracted, the way of extracting the propagation network is optional.

Moreover, when such a configuration is employed, the transfer rate counting unit 202 obtains the information transfer rate, the user transfer rate, the average number of transferring, and the average time of transferring with reference to the information DB 2, and stores those pieces of obtained information in the information DB 2. The transfer rate counting unit 202 obtains the information transfer rate for each transmitted information ID based on the transmission record information stored in the information DB 2. The transfer rate counting unit 202 obtains, as the information transfer rate, a rate of information transferred based on the transmission record information, but the present invention is not limited to this operation, and a value gained by weighting the rate of the information transferred by the importance level of that information may be obtained as the information transfer rate. Moreover, the transfer rate counting unit 202 obtains the user transfer rate, the average number of transferring and the average time of transferring for each user based on the transmission record information stored in the information DB 2.

Furthermore, when such a configuration is employed, the link information counting unit 203 refers to the information DB 2, obtains the strength of a link between the users, and stores the obtained strength in the information DB 2. The link information counting unit 203 obtains the strength of each link among the users based on the transmission record information stored in the information DB 2. Regarding how to obtain the strength of the link, for example, the strength proportional to the number of communications between the users may be obtained, and may be obtained based on the number of communications between the users and the contents of each communication.

In the above explanation, the information obtaining unit 11, the candidate propagation NW obtaining unit 12, the recommended propagation NW specifying unit 13, the display generator unit 14, and the setting unit 15, etc., were explained, but those structural elements may be integral to one another, or may be segmentalized. That is, as far as the operation of the information transmission support system of the present invention can be realized, the structural elements are not limited to the above-explained examples.

The above-explained hardware configuration and flowchart are merely examples, and can be changed and modified arbitrarily.

The major part for executing the information transmission support process and configured by the control unit 21, the main memory unit 22, the external memory unit 23, the operation unit 24, and the internal bus 20, etc., can be realized by not only an exclusive system but also a typical computer system. For example, a computer program for executing the above-explained operations is stored in a computer-readable recording medium (e.g., a flexible disk, a CD-ROM, or a DVD-ROM) and distributed, and such a computer program is installed in a computer to configure the information transmission support system 101 and the information transmission support system 102 executing the above-explained processes. Moreover, such a computer program may be stored in a storage device of a server device over a communication network like the Internet, and downloaded to a typical computer system to configure the information transmission support system 101 and the information transmission support system 102.

When an OS (operating system) and an application program realize the functions of the information transmission support system 101 and the information transmission support system 102 in a shared manner or such functions are realized by the cooperative operation of the OS and the application program, only the application program portion may be stored in a recording medium or a storage device.

Moreover, the computer program may be superimposed on carrier waves and distributed over a communication network. For example, the computer program may be posted on a board (BBS: Bulletin Board System) over the communication network, and may be distributed via the network. The computer program is run and executed like the other application programs under the control of the OS to execute the above-explained processes.

A part of or all of the above-explained embodiments can be described as in the following supplementary notes, but the present invention is not limited to the following supplementary notes.

(Supplementary Note 1)

An information transmission support device that supports users to exchange information with one another via a communication network, and the information transmission support device includes:

a transmission-intended information obtaining means for obtaining transmission kind information indicating a kind of transmission-intended information to be transmitted to a user by an information sender;

a candidate propagation network obtaining means for searching and obtaining candidate propagation networks corresponding to the transmission kind information among propagation networks each comprising information on a sender user, a recipient user, a kind of information transmitted from the sender user to the recipient user, and a number, a probability, a time, or a combination thereof of transmission of the information of the kind from the sender user to the recipient user;

a recommended propagation network specifying means for obtaining, as a recommended propagation network, the candidate propagation network having a highest expected value of a total number of the users to whom information will be propagated within a predetermined time among the candidate propagation networks; and

a presenting means for presenting the recommended propagation network to the information sender.

(Supplementary Note 2)

The information transmission support device of the supplementary note 1, in which

the propagation network includes link information indicating a strength of a relationship between the users, transfer rate information indicating a probability of information transferred, and/or user information indicating an attribute of the user, and

the recommended propagation network specifying means obtains the recommended propagation network based on the link information, the transfer rate information, and/or the user information.

(Supplementary Note 3)

The information transmission support device of supplementary note 1 or 2, further includes:

a time setting means for setting the predetermined time; and

a fixed-value setting means for setting a number of initial users indicating a number of users to whom the transmission-intended information will be directly transmitted or a number of propagated users indicating a total number of the users to whom information will be propagated, in which

the recommended propagation network specifying means

obtains, as the recommended propagation network, a combination of the candidate propagation networks corresponding to the number of the initial users and having a highest expected value of a pure total number of the users to whom information will be propagated within the predetermined time when the fixed-value setting means sets the number of the initial users, and

obtains, as the recommended propagation network, a combination of the candidate propagation networks having an expected value of the total number of the users to whom information will be propagated within the predetermined time matching with the number of the propagated users and having a smallest number of the initial users when the fixed-value setting means sets the number of the propagated users.

(Supplementary Note 4)

The information transmission support device of the supplementary note 3, in which the recommended propagation network specifying means obtains duplicated users as a user when obtaining the expected value of the total number of the users to whom information will be propagated.

(Supplementary Note 5)

The information transmission support device according to any one of supplementary notes 1 to 4, in which

the transmission-intended information obtaining means further obtains target attribute information indicating an attribute of the user to whom the information sender wants to transmit the transmission-intended information, and

the recommended propagation network specifying means obtains, as the recommended propagation network among the candidate propagation networks, the candidate propagation network having a highest expected value of the total number of the users having user information matching the target attribute information among the users to whom information will be propagated within the predetermined time based on the user information indicating an attribute of the user corresponding to each candidate propagation network.

(Supplementary Note 6)

The information transmission support device of the supplementary note 3, in which

the time setting means automatically sets the predetermined time based on the propagation network, and

the fixed-value setting means automatically sets the number of the initial users indicating the number of the users to whom the transmission-intended information will be directly transmitted or the number of the propagated users indicating the total number of the users to whom information will be propagated based on the propagation network.

(Supplementary Note 7)

The information transmission support device according to any one of supplementary notes 1 to 6, in which

the transmission-intended information obtaining means comprises keyword extracting means for extracting equal to or greater than one keyword contained in the transmission-intended information, and

the candidate propagation network obtaining means searches and obtains, as the candidate propagation network, the propagation network of similar transmitted information consistent with or similar to the transmission-intended information based on the keyword extracted by the keyword extracting means.

(Supplementary Note 8)

The information transmission support device of the supplementary note 7, in which

the keyword extracting means extracts the keyword from the transmission-intended information based on an TF-IDF technique, and takes a word having a TF value becoming high within a certain period as the keyword.

(Supplementary Note 9)

The information transmission support device of the supplementary note 7 or 8, in which

the candidate propagation network obtaining means further comprises degree-of-similarity counting means for obtaining a degree of similarity between the transmission-intended information and the similar transmitted information, and

the recommended propagation network specifying means obtains the recommended propagation network based on the degree of similarity obtained by the degree-of-similarity counting means.

(Supplementary Note 10)

The information transmission support device of the supplementary note 9, in which

the recommended propagation network specifying means compares the degree of similarity obtained by the degree-of-similarity counting means with a threshold set in advance, and when the degree of similarity is higher than the threshold, obtains the propagation network of the similar transmitted information at the degree of similarity as the recommended propagation network.

(Supplementary Note 11)

The information transmission support device of the supplementary note 9 or 10, in which the recommended propagation network specifying means multiplies the expected value by a coefficient based on the degree of similarity obtained by the degree-of-similarity counting means, and obtains the recommended propagation network based on the multiplied expected value.

(Supplementary Note 12)

The information transmission support device of the supplementary note 2, in which the recommended propagation network specifying means obtains an approximation formula for obtaining a number of the users to whom information will be propagated based on the transfer rate information, and obtains the expected value based on the approximation formula.

(Supplementary Note 13)

The information transmission support device of the supplementary note 2, in which the recommended propagation network specifying means respectively obtains, based on the link information, the transfer rate information and/or the user information, a value for evaluating a measure of propagation proportional to the strength of each link and a measure of transmission from an initial user to another user based on a number of the users, and a value for evaluating a measure of transmission from the user to whom information is transmitted from the initial user to further other users based on the number of the users, and obtains the expected value of the number of the users to whom information will be propagated based on the obtained values.

(Supplementary Note 14)

An information transmission support method for supporting users to exchange information with one another via a communication network, the method includes:

a transmission-intended information obtaining step for obtaining transmission kind information indicating a kind of transmission-intended information to be transmitted to a user by an information sender;

a candidate propagation network obtaining step for searching and obtaining candidate propagation networks corresponding to the transmission kind information among propagation networks each comprising information on a sender user, a recipient user, a kind of information transmitted from the sender user to the recipient user, and a number, a probability, a time, or a combination thereof of transmission of the information of the kind from the sender user to the recipient user;

a recommended propagation network specifying step for obtaining, as a recommended propagation network, the candidate propagation network having a highest expected value of a total number of the users to whom information will be propagated within a predetermined time among the candidate propagation networks; and

a presenting step for presenting the recommended propagation network to the information sender.

(Supplementary Note 15)

A computer-readable recording medium having stored therein a program that allows a computer to execute:

a transmission-intended information obtaining step for obtaining transmission kind information indicating a kind of transmission-intended information to be transmitted to a user by an information sender;

a candidate propagation network obtaining step for searching and obtaining candidate propagation networks corresponding to the transmission kind information among propagation networks each comprising information on a sender user, a recipient user, a kind of information transmitted from the sender user to the recipient user, and a number, a probability, a time, or a combination thereof of transmission of the information of the kind from the sender user to the recipient user;

a recommended propagation network specifying step for obtaining, as a recommended propagation network, the candidate propagation network having a highest expected value of a total number of the users to whom information will be propagated within a predetermined time among the candidate propagation networks; and

a presenting step for presenting the recommended propagation network to the information sender.

The present invention can be carried out through various embodiments and modifications without departing from the broad scope and spirit of the present invention. The above-explained embodiments are to explain the present invention, and are not to limit the scope and spirit of the present invention. That is, the scope and spirit of the present invention should be determined based on the appended claims rather than the above-explained embodiments. Various modifications within the scope of the appended claims and equivalents thereto should be within the scope and spirit of the present invention.

This application is based on Japanese Patent Application No. 2010-000311 filed on Jan. 5, 2010. The whole specification, claims, and drawings of Japanese Patent Application No. 2010-000311 are herein incorporated in this specification by reference.

### DESCRIPTION OF REFERENCE NUMERALS

1, 1B, 3 Information transmission support device
2 Information database
6 Sender terminal
7, 71 Network
8 Mobile communication network
9, 10 User terminal
11 Information obtaining unit
12 Candidate propagation NW obtaining unit
13 Recommended propagation NW specifying unit
14 Display generator unit
15 Setting unit
21 Control unit
22 Main memory unit
23 External memory unit
24 Operation unit
25 Display unit
26 Input/output unit
27 Transmitter/receiver unit
29 Control program
101, 102 Information transmission support system
111 Keyword extracting unit
121 Degree-of-similarity counting unit
201 Propagation NW extracting unit
202 Transfer rate counting unit
203 Link information counting unit

1.-15. (canceled)

16. An information transmission support device that supports users to exchange information with one another via a communication network, the information transmission support device comprising:
a transmission-intended information obtaining unit for obtaining transmission kind information indicating a kind of transmission-intended information to be transmitted to a user by an information sender;
a time setting unit for setting a predetermined time;
a fixed-value setting unit for setting a number of initial users indicating a number of the users to whom the transmission-intended information will be directly transmitted or a number of propagated users indicating a total number of the users to whom information will be propagated;
a candidate propagation network obtaining unit for searching and obtaining candidate propagation networks corresponding to the transmission kind information among propagation networks each comprising information on a sender user, a recipient user, a kind of information transmitted from the sender user to the recipient user, and a number, a probability, a time, or a combination thereof of transmission of the information of the kind from the sender user to the recipient user;
a recommended propagation network specifying unit for obtaining, as a recommended propagation network, the candidate propagation network having a highest expected value of the total number of the users to whom information will be propagated within the predetermined time among the candidate propagation networks; and
a presenting unit for presenting the recommended propagation network to the information sender,
the recommended propagation network specifying unit
obtains, as the recommended propagation network, a combination of the candidate propagation networks corresponding to the number of the initial users and having a highest expected value of a pure total number of the users to whom information will be propagated within the predetermined time when the fixed-value setting unit sets the number of the initial users, and
obtains, as the recommended propagation network, a combination of the candidate propagation networks which has an expected value of the total number of the users to whom information will be propagated within the predetermined time matching the number of the propagated users and which has a smallest number of the initial users when the fixed-value setting unit sets the number of the propagated users.

17. The information transmission support device according to claim 16, wherein
the propagation network includes link information indicating a strength of a relationship between the users, transfer rate information indicating a probability of information transferred, and/or user information indicating an attribute of the user, and
the recommended propagation network specifying unit obtains the recommended propagation network based on the link information, the transfer rate information, and/or the user information.

18. The information transmission support device according to claim 16, wherein the recommended propagation network specifying unit obtains duplicated users as a user when obtaining the expected value of the total number of the users to whom information will be propagated.

19. The information transmission support device according to claim 16, wherein
the transmission-intended information obtaining unit further obtains target attribute information indicating an attribute of the user to whom the information sender wants to transmit the transmission-intended information, and
the recommended propagation network specifying unit obtains, as the recommended propagation network among the candidate propagation networks, the candidate propagation network having a highest expected value of the total number of the users having user information matching the target attribute information among the users to whom information will be propagated within the predetermined time based on the user information indicating an attribute of the user corresponding to each candidate propagation network.

20. The information transmission support device according to claim 16, wherein
the time setting unit automatically sets the predetermined time based on the propagation network, and
the fixed-value setting unit automatically sets the number of the initial users indicating the number of the users to whom the transmission-intended information will be directly transmitted or the number of the propagated users indicating the total number of the users to whom information will be propagated based on the propagation network.

21. The information transmission support device according to claim 16, wherein
the transmission-intended information obtaining unit comprises keyword extracting unit for extracting equal to or greater than one keyword contained in the transmission-intended information, and
the candidate propagation network obtaining unit searches and obtains, as the candidate propagation network, the propagation network of similar transmitted information consistent with or similar to the transmission-intended information based on the keyword extracted by the keyword extracting unit.

22. The information transmission support device according to claim 21, wherein the keyword extracting unit extracts the keyword from the transmission-intended information based on an TF-IDF technique, and takes a word having a TF value becoming high within a certain period as the keyword.

23. The information transmission support device according to claim 21, wherein
the candidate propagation network obtaining unit further comprises degree-of-similarity counting unit for obtaining a degree of similarity between the transmission-intended information and the similar transmitted information, and
the recommended propagation network specifying unit obtains the recommended propagation network based on the degree of similarity obtained by the degree-of-similarity counting unit.

24. The information transmission support device according to claim 23, wherein the recommended propagation network specifying unit compares the degree of similarity obtained by the degree-of-similarity counting unit with a threshold set in advance, and when the degree of similarity is higher than the threshold, obtains the propagation network of the similar transmitted information at the degree of similarity as the recommended propagation network.

25. The information transmission support device according to claim 23, wherein the recommended propagation network specifying unit multiplies the expected value by a coefficient based on the degree of similarity obtained by the degree-of-similarity counting unit, and obtains the recommended propagation network based on the multiplied expected value.

26. The information transmission support device according to claim 17, wherein the recommended propagation network specifying unit obtains an approximation formula for obtaining a number of the users to whom information will be propagated based on the transfer rate information, and obtains the expected value based on the approximation formula.

27. The information transmission support device according to claim 17, wherein the recommended propagation network specifying unit respectively obtains, based on the link information, the transfer rate information and/or the user information, a value for evaluating a measure of propagation proportional to the strength of each link and a measure of transmission from an initial user to another user based on a number of the users, and a value for evaluating a measure of transmission from the user to whom information is transmitted from the initial user to further other users based on the number of the users, and obtains the expected value of the number of the users to whom information will be propagated based on the obtained values.

28. An information transmission support method for supporting users to exchange information with one another via a communication network, the method comprising:
a transmission-intended information obtaining step for obtaining transmission kind information indicating a kind of transmission-intended information to be transmitted to a user by an information sender;
a time setting step for setting a predetermined time;
a fixed-value setting step for setting a number of initial users indicating a number of the users to whom the transmission-intended information will be directly transmitted or a number of propagated users indicating a total number of the users to whom information will be propagated;
a candidate propagation network obtaining step for searching and obtaining candidate propagation networks corresponding to the transmission kind information among propagation networks each comprising information on a sender user, a recipient user, a kind of information transmitted from the sender user to the recipient user, and a number, a probability, a time, or a combination thereof of transmission of the information of the kind from the sender user to the recipient user;
a recommended propagation network specifying step for obtaining, as a recommended propagation network, the candidate propagation network having a highest expected value of the total number of the users to whom information will be propagated within the predetermined time among the candidate propagation networks; and
a presenting step for presenting the recommended propagation network to the information sender,
in the recommended propagation network specifying step,
a combination of the candidate propagation networks corresponding to the number of the initial users and having a highest expected value of a pure total number of the users to whom information will be propagated within the predetermined time is obtained as the recommended propagation network when the number of the initial users is set in the fixed-value setting step, and
a combination of the candidate propagation networks which has an expected value of the total number of the users to whom information will be propagated within the predetermined time matching the number of the propagated users and which has a smallest number of the initial users is obtained as the recommended propagation network when the number of the propagated users is set in the fixed-value setting step.

29. A computer-readable recording medium having stored therein a program that allows a computer to execute:
a transmission-intended information obtaining step for obtaining transmission kind information indicating a kind of transmission-intended information to be transmitted to a user by an information sender;
a time setting step for setting a predetermined time;
a fixed-value setting step for setting a number of initial users indicating a number of the users to whom the transmission-intended information will be directly transmitted or a number of propagated users indicating a total number of the users to whom information will be propagated;
a candidate propagation network obtaining step for searching and obtaining candidate propagation networks corresponding to the transmission kind information among propagation networks each comprising information on a sender user, a recipient user, a kind of information transmitted from the sender user to the recipient user, and a number, a probability, a time, or a combination thereof of transmission of the information of the kind from the sender user to the recipient user;
a recommended propagation network specifying step for obtaining, as a recommended propagation network, the candidate propagation network having a highest expected value of the total number of the users to whom information will be propagated within the predetermined time among the candidate propagation networks; and
a presenting step for presenting the recommended propagation network to the information sender,
in the recommended propagation network specifying step,
a combination of the candidate propagation networks corresponding to the number of the initial users and having a highest expected value of a pure total number of the users to whom information will be propagated within the predetermined time is obtained as the recommended propagation network when the number of the initial users is set in the fixed-value setting step, and
a combination of the candidate propagation networks which has an expected value of the total number of the users to whom information will be propagated within the predetermined time matching the number of the propagated users and which has a smallest number of the initial users is obtained as the recommended propagation network when the number of the propagated users is set in the fixed-value setting step.

30. An information transmission support device that supports users to exchange information one another via a communication network, the information transmission support device comprising:
a transmission-intended information obtaining means for obtaining transmission kind information indicating a kind of transmission-intended information to be transmitted to a user by an information sender;
a time setting means for setting a predetermined time;
a fixed-value setting means for setting a number of initial users indicating a number of the users to whom the transmission-intended information will be directly transmitted or a number of propagated users indicating a total number of the users to whom information will be propagated;
a candidate propagation network obtaining means for searching and obtaining candidate propagation networks corresponding to the transmission kind information among propagation networks each comprising information on a sender user, a recipient user, a kind of information transmitted from the sender user to the recipient user, and a number, a probability, a time, or a combination thereof of transmission of the information of the kind from the sender user to the recipient user;
a recommended propagation network specifying means for obtaining, as a recommended propagation network, the candidate propagation network having a highest expected value of the total number of the users to whom information will be propagated within the predetermined time among the candidate propagation networks; and
a presenting means for presenting the recommended propagation network to the information sender,
the recommended propagation network specifying means
obtains, as the recommended propagation network, a combination of the candidate propagation networks corresponding to the number of the initial users and having a highest expected value of a pure total number of the users to whom information will be propagated within the predetermined time when the fixed-value setting means sets the number of the initial users, and
obtains, as the recommended propagation network, a combination of the candidate propagation networks which has an expected value of the total number of the users to whom information will be propagated within the predetermined time matching the number of the propagated users and which has a smallest number of the initial users when the fixed-value setting means sets the number of the propagated users.
